(19) United States
(12) Patent Application Publication
(10) Pub. No.: US 2008/0173521 A1
(43) Pub. Date: Jul. 24, 2008

(54) Grain and fertilizer conveyor

(76) Inventor: Lindsay David Hitch, (US)

Correspondence Address: ROBERT S. SMITH, 1131-0 TOLLAND TURNPIKE, SUITE 306, MANCHESTER, CT, 06040, US

(21) Appl. No.: 11/624,875

(22) Filed: Jan. 19, 2007

(51) Int. Cl. B65G 15/44

(52) U.S. Cl. 198/698

(57) ABSTRACT

The grain and fertiliser conveyor (10) of the present invention transports particulate material quickly and efficiently whilst minimising damage to the material (75) being transported. The conveyor includes an elongated housing (14) which houses a conveyor belt (16) adapted to receive material through a catchment hopper at a lower end of the housing and transport the material to the upper end of the housing for discharge therefrom. The conveyor belt (16) is both cleated (66) and bordered (68, 70) which allows for larger volumes of material to be conveyed without contacting the side walls of the housing (14) and hence minimising damage to the material. Further, the conveyor (10) includes a non-complex mechanism for tensioning and de-tensioning the belt (16). It is envisaged that the conveyor (10) of the present invention may supersede many conveyors and augers which are used today in the agricultural industry

### BACKGROUND OF THE INVENTION

Conveyors have been used in the transportation of grain since the 1800's. For granaries in particular, conveyors are ideal appliances in that they can run at relatively high speeds with a moderate expenditure of power. Conveyers of this type may be portable or fixed depending on their required purpose, and typically comprise a continuous belt fitted within a housing which includes both receiving and delivery means. Such conveyors can be used to handle grain from or into granaries, or simply to feed bins or sections of warehouses. Similarly, conveyors and augers are used during harvesting of grain, for example, where grain is required to be transported from the harvester itself to a storage cart moving alongside the harvester.

While conveyors of this kind are ideal for use with grain, they are also capable of rendering good service in handling other materials such as seeds and fertiliser, as well as heavier materials such as coal and minerals. Accordingly, the scope of the present invention is not to be limited to applications associated only with grain.

Existing conveyor and auger arrangements suffer from several operating limitations. A primary disadvantage of such machinery is in damage to the material being transported. The belts of such conveyors are generally flat belts which move adjacent the side walls of the outer housing of the conveyor. Damage is typically caused when material becomes wedged between the rotating band and the outer housing. This results in general degradation of the quality of the material being transported, and in the case of grain and seeds, damage in the form of cracking may increase susceptibility to infestation by insects.

Further disadvantage associated with existing agricultural conveyors include their complex belt tensioning and de-tensioning means, and the fact that their configurations often do not allow for an enclosed outer housing, this resulting in high levels of dust and spillage of material.

It is therefore an object of the present invention to overcome at least some of the aforementioned problems or to provide the public with a useful alternative.

### SUMMARY OF THE INVENTION

Therefore in one form of the invention there is proposed a conveyor of the type used to transport material said conveyor characterised by:
a longitudinal housing;
a feeding means associated with a lower end of said longitudinal housing into which said material is adapted to be fed; and
a longitudinal conveyor belt adapted to receive said material from the feeding means and transport the material to an upper end of said longitudinal housing where the material may be discharged, said conveyor belt including longitudinal borders on either side thereof said borders adapted to prevent the material from contacting said housing when the conveyor belt is moving.

The present invention therefore relates to a conveyor for transporting agricultural material such as grain, seed and fertiliser from a

Preferably said conveyor belt further includes a plurality of cleats which are spaced apart along the length of the conveyor belt and which extend transversely in between said borders.

In preference said conveyor belt is continuous and is maintained in tension by a first and second roller around which said conveyor belt extends, said first roller positioned at the lower end of said longitudinal housing and said second roller positioned at the upper end of said longitudinal housing.

In preference said first roller is a belt tension roller that is both moveable and lockable along at least a portion of said longitudinal housing, and said second roller is a drive roller coupled to a drive means for actuating movement of said conveyor belt.

Preferably tensioning of said belt may be achieved by moving said first roller away from said second roller, and de-tensioning of said belt may be achieved by moving said first roller toward said second roller.

Preferably said longitudinal borders of said conveyor belt are flexible and also corrugated so that they may appropriately expand when the conveyor belt circles around said first or second roller and compress when said conveyor belt is flat.

Preferably said longitudinal housing encloses said conveyor.

In preference said longitudinal housing is of a rectangular cross-section including side walls adjacent the edges of said conveyor belt.

Advantageously said drive means is a hydraulic motor mounted to said longitudinal housing and coupled to said drive roller via a pulley system.

Preferably said drive means further includes a hydraulic control valve which may be adjusted to control the amount of hydraulic fluid entering the hydraulic motor.

In preference said feeding means is a catchment hopper.

In preference material is discharged from the upper end of said conveyor into an outlet nozzle and downwardly through a distributor hose.

In a further form of the invention there is proposed a conveyor for use in handling agricultural material said conveyor characterised by:
an enclosed elongated housing including an upper end and a lower end, said lower end having associated therewith a catchment hopper into which material to be conveyed is to be fed;
a conveyor belt adapted to move longitudinally adjacent side walls of said enclosed elongated housing, said conveyor belt adapted to receive said material entering said catchment hopper and transport the material to said upper end of the housing for discharge therefrom, said conveyor belt including flexible corrugated borders extending outwardly therefrom said borders adapted to prevent said material from contacting said side walls of the housing when the conveyor belt is rotating.

Preferably said conveyor belt further includes a plurality of transverse cleats which are spaced apart along the length of the conveyor belt.

Advantageously said cleats extend outwardly from said conveyor belt at an angle of approximately 15 degrees.

Advantageously said conveyor may be fixed or portable.

### BRIEF DESCRIPTION OF THE DRAWINGS

The accompanying drawings, which are incorporated in and constitute a part of this specification, illustrate several implementations of the invention and, together with the description, serve to explain the advantages and principles of the invention. In the drawings:

FIG. 1 illustrates a perspective view of a conveyor in accordance with the present invention;

FIG. 2 illustrates a cross-sectional side view of the conveyor of FIG. 1;

FIG. 3 illustrates an enlarged perspective view of the upper or discharge end of the conveyor of FIG. 1;

FIG. 4 illustrates an enlarged perspective view of the lower or feed end of the conveyor of FIG. 1;

FIG. 5a illustrates an enlarged perspective view of a portion of the cleated and bordered belt of the conveyor of FIG. 1;

FIG. 5b illustrates a top view of the portion of cleated and bordered belt of FIG. 5a; and

FIG. 6 illustrates a perspective view of the conveyor of FIG. 1 being used according to one embodiment of the present invention.

### DESCRIPTION OF THE PREFERRED EMBODIMENTS

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts.

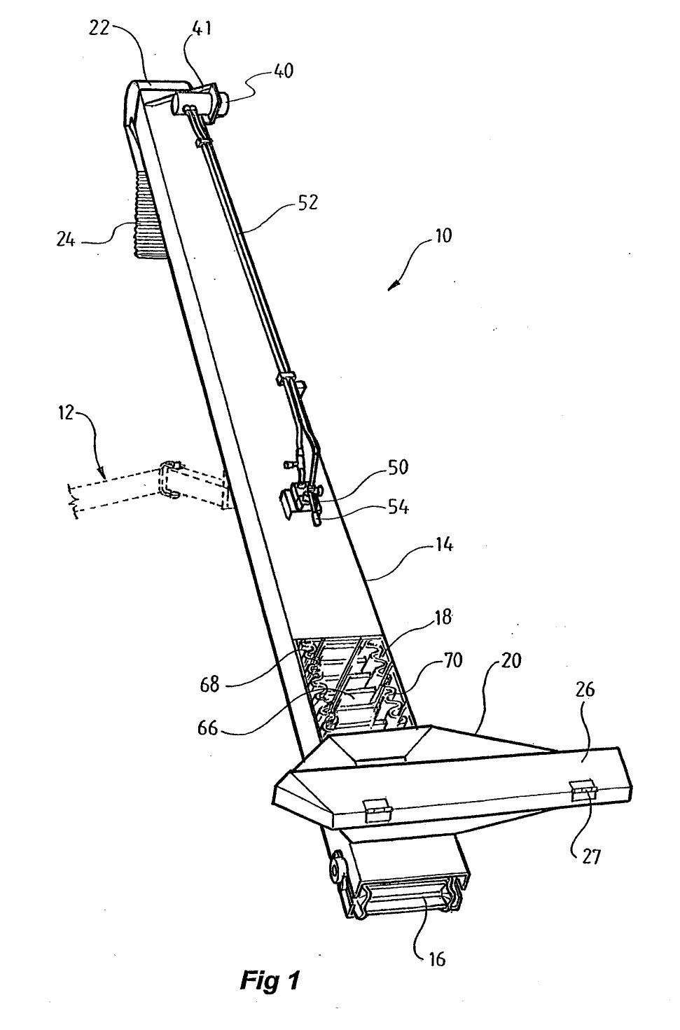

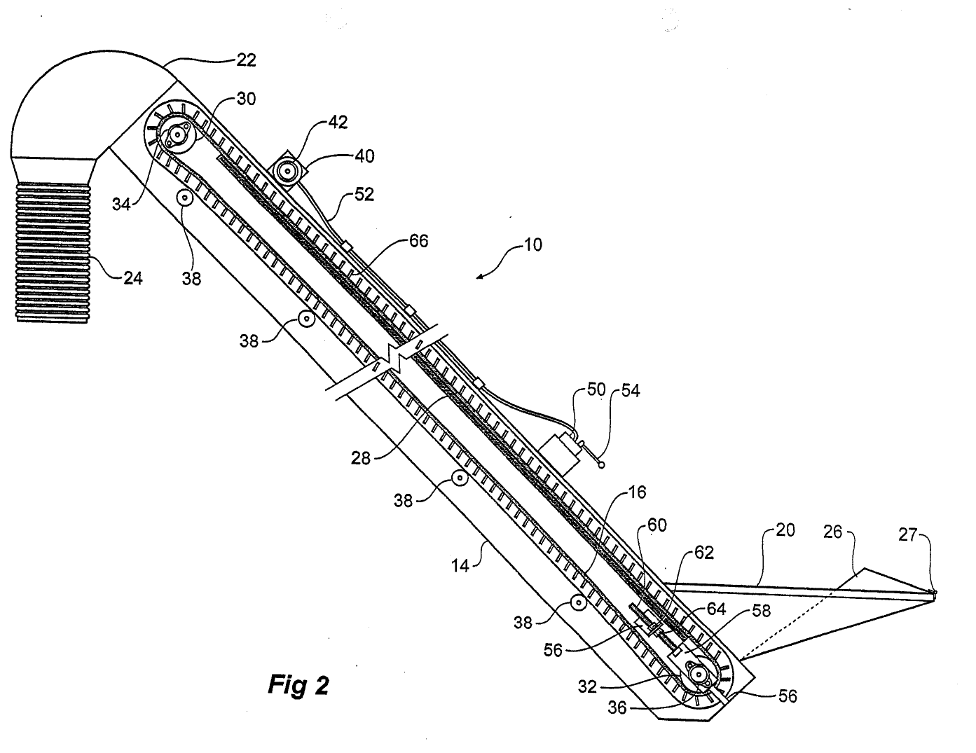

FIGS. 1-2 illustrate the conveyor 10 of the present invention. The objective of the grain and fertiliser conveyor 10 is to transport particulate material quickly and efficiently whilst minimising damage to the material being transported. The conveyor 10 is illustrated in some of the drawings as being fixed to a pivotable mounting bracket 12 at an angle of approximately 45 degrees, however, it is to be understood that the angle of the conveyor 10 may be adjusted to suit different situations, and that alternate mounting means may be used. For example, the conveyor may well be portable whereby its mounting frame is supported above wheels.

The conveyor 10 includes an elongated housing or chute 14 which houses a continuous belt 16 upon which material is to be transported. The housing 14, which is preferably formed of sheet metal, includes a rectangular cross-section and open ends to permit discharge of material at its upper or discharge end, and to permit belt tensioning at its lower or feed end, as will be described. The enclosed configuration of the conveyor housing 14 ensures that dust and spillage is kept to a minimum, a known problem with some existing conveyors. A transparent window 18 exists in the top wall of the housing 14 to permit inspection of the belt 16.

Adjacent the lower or feed end of the conveyor 10 is a catchment hopper 20 having walls of a size and slope to direct material toward the belt 16 during feeding of material. Mounted at the upper end of the conveyor 10 is an outlet nozzle 22 into which material is discharged from the moving conveyor belt 16, the material then dropping by way of gravity through a flexible distribution hose 24 connected below the outlet nozzle 22. The catchment hopper 20 may also include an adjustor (not shown) for shifting its longitudinal position along the housing 14 and a trap door (not shown) for removing material that is left in the bottom of the catchment hopper 20. It is to be understood that alternate means for feeding and discharging from the conveyor 10 may equally well be used.

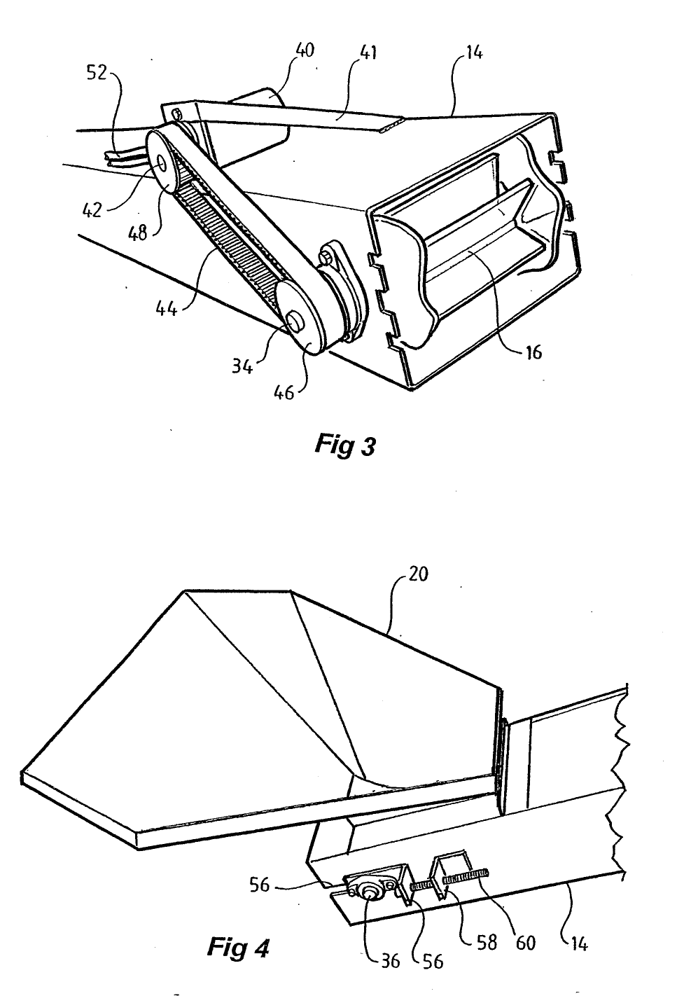

The belt 16 extends within and along the elongated housing 14 and is maintained and supported in the position shown in FIG. 2 by a belt support floor 28 together with an assortment of rollers. The primary rollers used to tension the belt are the drive roller 30 mounted within the discharge end of the conveyor 10, as shown in the enlarged view of FIG. 3, and the belt tension roller 32 mounted within the feed end of the conveyor 10, as shown in the enlarged view of FIG. 4. Both the drive roller 30 and belt tension roller 32 are rotatable about their respective shafts 34 and 36 which are each secured between the side walls of the housing 14 in a transverse configuration. A series of rotatable belt idle rollers 38 are also located below the belt 16 to both guide and tension the belt 16 during operation. In preference, the drive roller 30 is rubber coated.

The drive roller 30, which causes the belt 16 to move when it rotates, is driven by a motor 40 mounted on the upper face of the discharge end of the conveyor 10 by a bracket 41. Coupling of the motor drive shaft 42 and the drive roller shaft 34 is achieved via a continuous drive belt 44 extending between two pulleys 46 and 48 associated with the drive roller shaft 34 and motor 40 respectively. Thus, the speed at which the belt 16 moves is dependant upon the speed at which the motor drive shaft 42 rotates.

The illustrated motor 40 is of the hydraulic type whereby a hydraulic pump (not shown) is used to pump hydraulic fluid, in this case oil, to the hydraulic motor 40 via a hydraulic control valve 50 through hose 52. The hydraulic control valve 50 is mounted toward the lower end of the conveyor 10 and includes manual means in the form of a valve handle 54 to control the amount of fluid which is pumped to the motor 40. Hence, the conveyor belt speed is controlled through control valve 50. It is to be understood that the means for driving the drive belt 30 need not necessarily be hydraulic. For example, the hydraulic motor 40 could well be replaced by a single or three phase electric motor (not shown).

As those skilled in the art will appreciate, the conveyor belt and rollers may be required to be repaired or replaced at particular times during the life of the conveyor 10, or at particular times the belt 16 may simply require tensioning. The conveyor 10 of the present invention allows for both tensioning and de-tensioning of the belt 16 in such circumstances because the belt tension roller 32 is both moveable and fixable along the longitudinal axis of the housing 14. The housing 14 includes a longitudinal track 56 which extends a short distance from the lower end of the housing 14 along its side walls, and allows for such movement in that the belt tension roller shaft 36 extends within the track 56 and hence may be moved therealong.

As can be seen clearly in FIG. 4, connected to the belt tension roller shaft 36 is a first bracket 56 and fixedly mounted to the outside of the housing 14 adjacent the belt tension roller 32 is a second bracket 58. Connecting brackets 56 and 58 is a threaded bolt 60 which is fixedly attached to the first bracket 56 and which extends through the fixed second bracket 58. As shown in FIG. 2, two nuts 62 and 64 are used to secure the bolt 60 to the second bracket 58 and are configured such that tightening of nut 62 causes the belt tension roller 32 to move away from the drive roller 30 thereby tensioning the belt 16, and tightening of nut 64 causes the belt tension roller 32 to move toward the drive roller 30 thereby de-tensioning the belt 16. It is to be understood that alternate means for moving bracket 56 toward and away from bracket 58 may be used.

As mentioned in the preamble of the invention, a problem associated with existing agricultural conveyors is the susceptibility for material to become wedged and damaged between the moving conveyor belt and the sides of the conveyor housing. The belt 16 of the present invention is both cleated and bordered so as to minimise damage to the material being conveyed. A plurality of spaced apart transverse cleats 66 protrude at an angle of approximately 15 degrees from the longitudinal belt 16. When material enters the conveyor through catchment hopper 20, it falls onto the moving belt 16 and the cleats 66 aid in transporting the material more gently and uniformly, particularly when the conveyor operates at narrow angles.

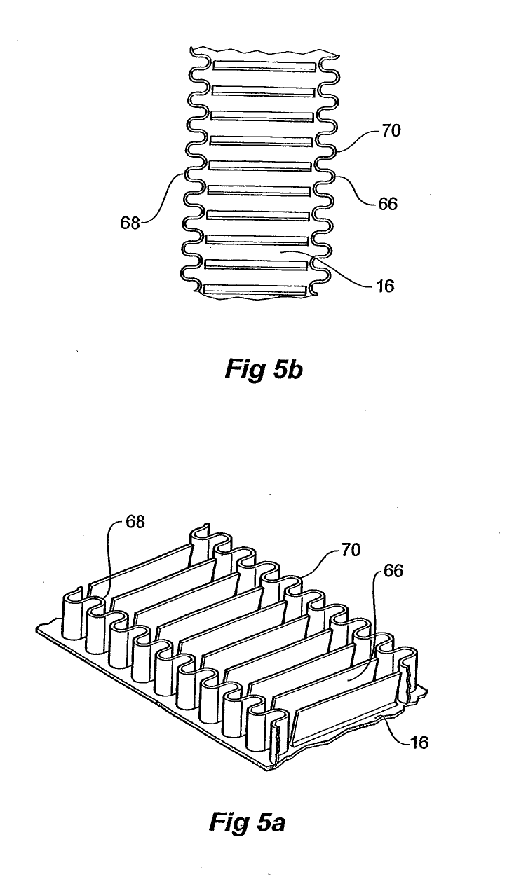

Also protruding outwards from the belt 16 are two corrugated borders 68 and 70 which extend longitudinally on either side of the cleats 66. The borders 68 and 70 are illustrated clearly in FIGS. 5a and 5b and their purpose is to prevent material from contacting the side walls of the housing 14, the current primary cause of damage to material such as grain, seeds and fertiliser. Thus, when material falls onto the belt 16, because the borders 68 and 70 are moving together with the belt and are not stationary, damage to grain located within the borders 68 and 70 is almost negligible. The borders 68 and 70 are corrugated so that they are able to stretch at the position where the belt 16 circles the rollers 30 and 32. The stretched nature of the corrugated borders 68 and 70 when circling the drive roller 30 can be seen in FIG. 3.

In preference, the belt 16 is manufactured of polyvinylchloride (PVC) or other material having similar properties, and the cleats 66 and borders 68 and 70 are appropriately bonded or fused thereto.

One should now be able to appreciate the advantages in using the conveyor 10 of the present invention. The conveyor 10 includes an enclosed housing 14 minimising dust and spillage, as well as a non-complex system for tensioning and de-tensioning the conveyor belt 16. Further, the belt 16 of the conveyor includes both cleats 66 and corrugated borders 68 and 70 which aid in transporting material more gently than hitherto known conveyors.

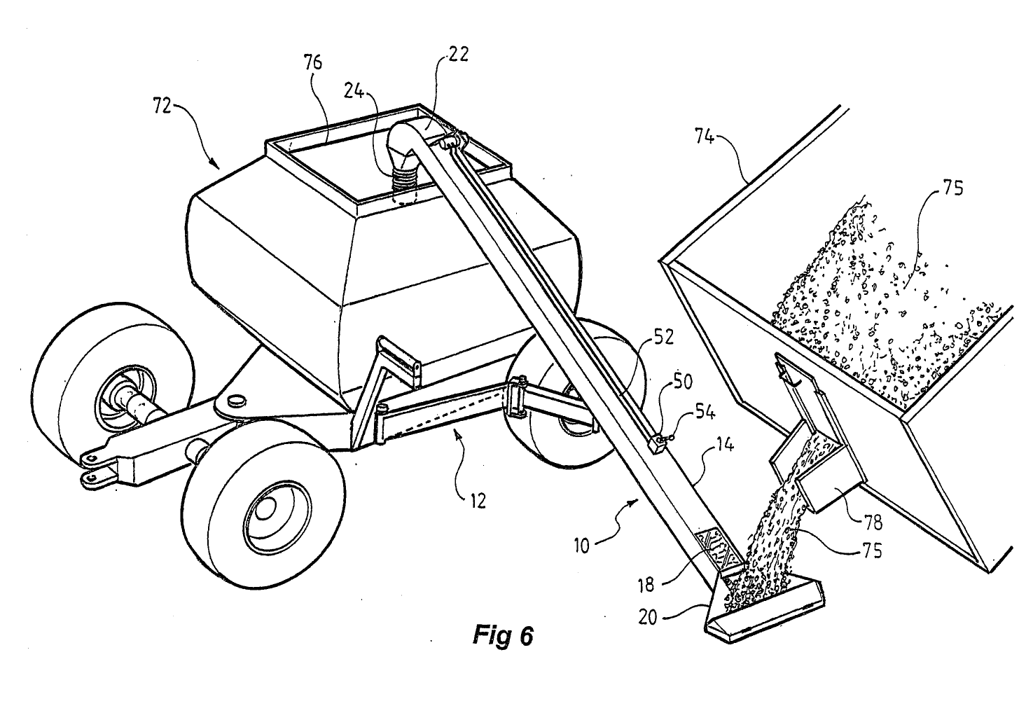

There are many agricultural applications which require the use of conveyors, and the features of the conveyor 10 of the present invention may be appropriately adapted to many of these applications. FIG. 6 illustrates one such use, that is, where the conveyor 10 is mounted to a mounting bracket 12 of a grain cart 72. Since grain carts of this sort are well known, its features are not described in any detail. In this situation, piles of grain 74 are fed into the catchment hopper 20 of the conveyor 10 to be discharged into the grain cart 72 through the flexible distributing hose 24 which extends into a grain cart access hatch 76. It is envisaged that the conveyor 10 of the present invention may supersede many conveyors and augers which are used today in the agricultural industry.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

In any claims that follow and in the summary of the invention, except where the context requires otherwise due to express language or necessary implication, the word “comprising” is used in the sense of “including”, i.e. the features specified may be associated with further features in various embodiments of the invention.

1-16. (canceled)

17. A conveyor of the type used to transport associated material said conveyor characterized by:
an elongated housing having an upper end and a lower end;
a feeding means associated with said lower end of said elongated housing being dimensioned and configured for receiving the associated material; and
an elongated conveyor belt adapted to receive said material from said feeding means and transport the material to said upper end of said elongated housing where the material is discharged, said conveyor belt including longitudinal borders on either side thereof, said borders adapted to prevent the material from contacting said housing when the conveyor belt is moving.

18. A conveyor as described in claim 17 wherein said conveyor belt further includes a plurality of cleats which are spaced apart along the length of the conveyor belt and which extend transversely in between said borders.

19. A conveyor as described in claim 17 wherein said conveyor belt is continuous and further includes first and second rollers cooperating with said belt to maintain tension by first and second rollers around which said conveyor belt extends, said first roller positioned at the lower end of said elongated housing and said second roller positioned at the upper end of said elongated housing.

20. A conveyor as described in claim 19 wherein said first roller is a belt tension roller that is both moveable and lockable along at least a portion of said elongated housing, and said second roller is a drive roller coupled to a drive means for actuating movement of said conveyor belt.

21. A conveyor as described in claim 17 wherein tensioning of said belt may be achieved by moving said first roller away from said second roller, and de-tensioning of said belt may be achieved by moving said first roller toward said second roller.

22. A conveyor as described in claim 17 wherein said longitudinal borders of said conveyor belt are flexible and also corrugated so that they may appropriately expand when the conveyor belt circles around said first or second roller and compress when said conveyor belt is flat.

23. A conveyor as described in claim 17 wherein said elongated housing encloses said conveyor.

24. A conveyor as described in claim 17 wherein said elongated housing is of a rectangular cross-section including side walls adjacent the edges of said conveyor belt.

25. A conveyor as described in claim 17 wherein said drive means is a hydraulic motor mounted to said elongated housing and coupled to said drive roller via a pulley system.

26. A conveyor according claim 17 wherein said drive means further includes a hydraulic control valve which may be adjusted to control the amount of hydraulic fluid entering the hydraulic motor.

27. A conveyor as described in claim 17 wherein said feeding means is a catchment hopper.

28. A conveyor as described in claim 17 wherein material is discharged from the upper end of said conveyor into an outlet nozzle and downwardly through a distributor hose.

29. A conveyor for handling agricultural material said conveyor characterized by:
an enclosed elongated housing including an upper end and a lower end, said lower end having associated therewith a catchment hopper into which material to be conveyed is to be fed, said housing including opposed longitudinally extending side walls;
a conveyor belt adapted to move intermediate said opposed longitudinally extending side walls of said enclosed elongated housing, said conveyor belt adapted to receive the material entering said catchment hopper and transporting the material to said upper end of the housing for discharge therefrom, said conveyor belt including flexible corrugated borders extending outwardly therefrom said borders adapted to prevent said material from contacting said side walls of the housing when the conveyor belt is rotating.

30. A conveyor belt as described in claim 29 wherein said conveyor belt further includes a plurality of transverse cleats which are spaced apart along the length of the conveyor belt.

31. A conveyor as described in claim 30 wherein said cleats extend outwardly from said conveyor belt at an angle of approximately 15 degrees.

32. A conveyor as described in any one of claims 29 wherein said conveyor is fixed.

33. A conveyor as described in any one of claims 29 wherein said conveyor is portable.
